(19) United States
(12) Patent Application Publication
(10) Pub. No.: US 2023/0223551 A1
(43) Pub. Date: Jul. 13, 2023

(54) LITHIUM-ION CELL WITH A HIGH ENERGY DENSITY

(71) Applicant: VARTA Microbattery GmbH, Ellwangen Jagst (DE)

(72) Inventors: Markus Pompetzki, Gaildorf (DE); Michael Gottschalk, Aalen (DE); David Ensling, Ellwangen (DE); Martin Elmer, Ellwangen (DE)

(21) Appl. No.: 17/928,284

(22) PCT Filed: May 17, 2021
(86) PCT No.: PCT/EP2021/062999

§ 371 Date: Nov. 29, 2022

(30) Foreign Application Priority Data
May 29, 2020 (EP) 20177599.6

(51) Int. Cl. H01M 4/75; H01M 10/0525; H01M 50/463; H01M 50/538; H01M 50/536; H01M 10/0587

(52) U.S. Cl. CPC H01M 4/75; H01M 10/0525; H01M 50/463; H01M 50/538; H01M 50/536; H01M 10/0587

(57) ABSTRACT

A lithium ion cell includes a ribbon-shaped electrode-separator assembly having an anode, a separator, and a cathode. The electrode-separator assembly has two terminal end faces or two terminal sides. The anode comprises a ribbon-shaped anode current collector having a first longitudinal edge, the cathode comprises a ribbon-shaped cathode current collector having a first longitudinal edge, and the electrode-separator assembly is enclosed in a housing. The first longitudinal edge of the anode current collector protrudes from one of the terminal end faces or terminal sides of the stack and the first longitudinal edge of the cathode current collector protrudes from the other. A contact sheet metal member is in direct contact with a respective longitudinal edge. A part of the housing serves as the contact sheet metal member and/or the contact sheet metal member forms a part of the housing enclosing the electrode-separator assembly.

### CROSS REFERENCE TO RELATED APPLICATIONS

This application is a U.S. National Phase application under 35 U.S.C. § 371 of International Application No. PCT/EP2021/062999, filed on May 17, 2021, and claims benefit to European Patent Application No. EP 20177599.6, filed on May 29, 2020. The International Application was published in German on Dec. 2, 2021 as WO 2021/239492 under PCT Article 21(2).

### FIELD

The disclosure relates to a lithium ion cell comprising an electrode-separator assembly.

### BACKGROUND

Electrochemical cells are capable of converting stored chemical energy into electrical energy by means of a redox reaction. The electrochemical cells generally comprise a positive and a negative electrode, which are separated from each other by a separator. During a discharge, electrons are released at the negative electrode as a result of an oxidation process. This results in an electron current that can be drawn off by an external electrical consumer, for which the electrochemical cell serves as an energy supplier. At the same time, an ion current corresponding to the electrode reaction occurs within the cell. This ion current passes through the separator and is made possible by an ion-conducting electrolyte.

If the discharge is reversible, the cell is said to be a secondary cell, which means that there is a possibility of reversing the conversion of chemical energy that took place during the discharge, and thus of charging the cell. The designation of the negative electrode as anode and the designation of the positive electrode as cathode, which is customary in secondary cells, refers to the discharge function of the electrochemical cell.

The widely used secondary lithium ion cells are based on the use of lithium, which can migrate between the electrodes of the cell in the form of ions. Lithium ion cells are characterised by a comparatively high energy density. The negative electrode and the positive electrode of a lithium ion cell are generally formed by so-called composite electrodes, which comprise electrochemically active components as well as electrochemically inactive components.

In principle, all materials that can absorb and release lithium ions can be used as electrochemically active components (active materials) for secondary lithium ion cells. For the negative electrode, carbon-based particles such as graphitic carbon are often used. Other, non-graphitic carbon materials that are suitable for the intercalation of lithium can also be used. In addition, metallic and semi-metallic materials that can be alloyed with lithium can also be used. For example, the elements tin, aluminium, antimony and silicon are able to form intermetallic phases with lithium. For example, lithium cobalt oxide (LiCoO₂), lithium manganese oxide (LiMn₂O₄), lithium titanate (Li₄Ti₅O₁₂) or lithium iron phosphate (LiFePO₄) or derivatives thereof can be used as active materials for the positive electrode. The electrochemically active materials are generally contained in particle form in the electrodes.

As electrochemically inactive components, the composite electrodes generally comprise a flat and/or ribbon-shaped current collector, for example a metallic foil, which is coated with an active material. For example, the current collector for the negative electrode (anode current collector) may be formed of copper or nickel and the current collector for the positive electrode (cathode current collector) may be formed of aluminium. Furthermore, the electrodes can comprise an electrode binder (e.g. polyvinylidene fluoride (PVDF) or another polymer, such as carboxymethyl cellulose). This ensures the mechanical stability of the electrodes and often also the adhesion of the active material to the current collectors. Furthermore, the electrodes can contain conductivity-improving additives and other additives.

As electrolytes, lithium ion cells generally comprise solutions of lithium salts such as lithium hexafluorophosphate (LiPF₆) in organic solvents (e.g. ethers and esters of carbonic acid).

In the production of a lithium ion cell, the composite electrodes are combined with one or more separators to form an assembly. In many cases, the electrodes and separators are joined together by lamination or bonding. The basic functionality of the cell can then be established by impregnating the assembly with the electrolyte.

In many cells, the assembly is flat so that several assemblies can be stacked flat on top of each other. Very often, however, the assembly is formed in the shape of a winding or is processed into a winding.

Generally, the assembly, whether wound or not, comprises the sequence positive electrode/separator/negative electrode. Often, assemblies are produced as so-called bi-cells with the possible sequences negative electrode/separator/positive electrode/separator/negative electrode or positive electrode/separator/negative electrode/separator/positive electrode.

For applications in the automotive sector, for e-bikes or also for other applications with high energy requirements, such as in tools, lithium ion cells with the highest possible energy density are needed that are also capable of being loaded with high currents during charging and discharging. Such cells are described, for example, in WO 2017/215900 A1.

Cells for these applications are often designed as cylindrical round cells, for example with the form factor 21×70 (diameter*height in mm) Cells of this type always comprise an assembly in the form of a winding. Modern lithium ion cells of this form factor can already achieve an energy density of up to 270 Wh/kg. However, this energy density is only considered an intermediate step. The market is already demanding cells with even higher energy densities.

### SUMMARY

In an embodiment, the present disclosure provides a lithium ion cell. The lithium ion cell includes a ribbon-shaped electrode-separator assembly comprising an anode, a separator, and a cathode in a sequence anode/separator/cathode. The electrode-separator assembly is (a) formed as a winding with two terminal end faces or (b) part of a stack formed of two or more identical electrode-separator assemblies, the stack having two terminal sides. The anode comprises a ribbon-shaped anode current collector having a first longitudinal edge, a second longitudinal edge, and two ends. The anode current collector comprises a strip-shaped main region loaded with a layer of negative electrode material and a free edge strip extending along the first longitudinal edge that is not loaded with the electrode material. The cathode comprises a ribbon-shaped cathode current collector having a first longitudinal edge, a second longitudinal edge, and two ends. The cathode current collector has a strip-shaped main region loaded with a layer of positive electrode material and a free edge strip extending along the first longitudinal edge that is not loaded with the electrode material. The electrode-separator assembly is enclosed in a housing. The anode and the cathode are formed and/or arranged within the electrode-separator assembly relative to each other such that the first longitudinal edge of the anode current collector protrudes from one of the terminal end faces or terminal sides of the stack and the first longitudinal edge of the cathode current collector protrudes from the other of the terminal end faces or terminal sides of the stack. A contact sheet metal member is in direct contact with a respective longitudinal edge, the respective longitudinal edge being the first longitudinal edge of the anode current collector or the first longitudinal edge of the cathode current collector. The contact sheet metal member is connected to the respective longitudinal edge by welding. A part of the housing serves as the contact sheet metal member and/or the contact sheet metal member forms a part of the housing enclosing the electrode-separator assembly.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 a top view of a current collector in an embodiment;

FIG. 2 a sectional view of the current collector shown in FIG. 1;

FIG. 3 a top view of an anode which can be processed into an electrode-separator assembly in the form of a winding;

FIG. 4 a sectional view of the anode shown in FIG. 3;

FIG. 5 a top view of an electrode-separator assembly made using the anode shown in FIG. 3;

FIG. 6 a sectional view of the electrode-separator assembly shown in FIG. 5;

FIG. 7 a sectional view of an embodiment in the form of a cylindrical round cell;

FIG. 8 a sectional view of a further embodiment in the form of a cylindrical round cell;

FIG. 9 a sectional view of a further embodiment in the form of a cylindrical round cell;

FIG. 10 a sectional view of a further embodiment in the form of a cylindrical round cell;

FIG. 11 a sectional view of a further embodiment in the form of a cylindrical round cell; and

FIG. 12 an illustration of a method of manufacturing the cell shown in FIG. 11.

### DETAILED DESCRIPTION

When developing improved lithium ion cells, however, there are other factors to consider than just energy density. Extremely important parameters are also the internal resistance of the cells, which should be kept as low as possible to reduce power losses during charging and discharging, and the thermal connection of the electrodes, which can be essential for temperature regulation of the cell. These parameters are also very important for cylindrical round cells that contain an assembly in the form of a winding. When cells are fast-charged, heat build-up can occur in the cells due to power losses, which can lead to massive thermo-mechanical stresses and subsequently to deformation and damage to the cell structure. The risk consists in particular if the electrical connection of the current collectors is made via separate electrical conductor tabs welded to the current collectors, which protrude axially from wound assemblies, as heating can occur locally at these conductor tabs during heavy loads during charging or discharging.

The present disclosure provides lithium ion cells which are characterised by an improved energy density compared to the prior art and which at the same time have excellent characteristics with regard to their internal resistance and their passive heat dissipation capabilities.

According to a first aspect, the disclosure provides a lithium ion cell including the immediately following features a. to i.:

a. The cell comprises a ribbon-shaped electrode-separator assembly with the sequence anode/separator/cathode.

b. The anode comprises a ribbon-shaped anode current collector having first and second longitudinal edges and two ends.

c. The anode current collector has a strip-shaped main region loaded with a layer of negative electrode material and a free edge strip extending along the first longitudinal edge which is not loaded with the electrode material.

d. The cathode comprises a ribbon-shaped cathode current collector having first and second longitudinal edges and two ends.

e. The cathode current collector has a strip-shaped main region which is loaded with a layer of positive electrode material and a free edge strip which extends along the first longitudinal edge and which is not loaded with the electrode material.

f. The electrode-separator assembly is in the form of a winding with two terminal end faces or is part of a stack formed from two or more identical electrode-separator assemblies and having two terminal sides.

g. The electrode-separator assembly is enclosed in a housing, possibly together with the other identical electrode-separator assembly(s) of the stack.

h. The anode and the cathode are formed and/or arranged within the electrode-separator assembly relative to each other such that the first longitudinal edge of the anode current collector protrudes from one of the terminal end faces or sides of the stack, and the first longitudinal edge of the cathode current collector protrudes from the other of the terminal end faces or sides.

i. The cell has a contact sheet metal member which is in direct contact with one of the first longitudinal edges, preferably longitudinally.

j. The contact sheet metal member is connected to this longitudinal edge by welding.

Particularly preferably, the cell comprises two contact sheet metal members, one of which is in direct contact with the first longitudinal edge of the anode current collector and the other of which is in direct contact with the first longitudinal edge of the cathode current collector, wherein the contact sheet metal members and the longitudinal edges in contact therewith are each connected to one another by welding.

The current collectors have the function of electrically contacting the electrochemically active components contained in the electrode material over as large an area as possible. Preferably, the current collectors consist of a metal or are at least metallised on the surface. Suitable metals for the anode current collector are, for example, copper or nickel or other electrically conductive materials, in particular copper and nickel alloys or metals coated with nickel. Stainless steel is also generally a possibility. Suitable metals for the cathode current collector include aluminium or other electrically conductive materials, in particular aluminium alloys.

Preferably, the anode current collector and/or the cathode current collector is a ribbon-shaped metal foil with a thickness in the range of 4 μm to 30 μm.

In addition to films, other ribbon-shaped substrates such as metallic or metallised nonwovens or open-pored foams can also be used as current collectors.

The current collectors are preferably loaded on both sides with the respective electrode material.

In the area of the free edge strips, the metal of the respective current collector is free of the respective electrode material. Preferably, the metal of the respective current collector is uncovered there so that it is available for electrical contacting, for example by welding.

In some embodiments, however, the metal of the respective current collector in the area of the free edge strips may also be coated with a support material that is more thermally resistant than the current collector coated therewith.

“Thermally more resistant” should mean here that the support material retains a solid state at a temperature at which the metal of the current collector melts. It therefore either has a higher melting point than the metal or it sublimates or decomposes only at a temperature at which the metal has already melted.

Preferably, both the anode current collector and the cathode current collector each have at least one free edge strip that is not loaded with the respective electrode material. In a further development, it is preferred that both the at least one free edge strip of the anode current collector and the at least one free edge strip of the cathode current collector are coated with the support material. Particularly preferably, the same support material is used for each of the regions.

The support material which can be used can in principle be a metal or a metal alloy, provided that this or these has a higher melting point than the metal of which the surface which is coated with the support material consists of. In many embodiments, however, the lithium ion cell according to the first aspect of the disclosure is preferably characterised by at least one of the immediately following additional features a. to d.:

a. The support material is a non-metallic material.

b. The support material is an electrically insulating material.

c. The non-metallic material is a ceramic material, a glass-ceramic material or a glass.

d. The ceramic material is aluminium oxide (Al₂O₃), titanium oxide (TiO₂), um titanium nitride (TiN), titanium aluminium nitride (TiAlN) or titanium carbonitride (TiCN).

The support material is particularly preferably embodied according to the immediately preceding feature b. and especially preferably according to the immediately preceding feature d.

The term non-metallic material comprises in particular plastics, glasses and ceramic materials.

The term electrically insulating material is to be understood broadly in this context. In principle, it comprises any electrically insulating material, in particular also said plastics.

The term ceramic material is to be understood broadly. In particular, it includes carbides, nitrides, oxides, silicides or mixtures and derivatives of these compounds.

The term “glass-ceramic material” means in particular a material that comprises crystalline particles embedded in an amorphous glass phase.

The term “glass” basically means any inorganic glass that meets the criteria for thermal stability defined above and that is chemically stable with respect to an electrolyte that may be present in the cell.

Particularly preferably, the anode current collector consists of copper or a copper alloy while at the same time the cathode current collector consists of aluminium or an aluminium alloy and the support material is aluminium oxide or titanium oxide.

It may be further preferred that free edge strips of the anode and/or the cathode current collector are coated with a strip of the support material.

The strip-shaped main regions of the anode current collector and the cathode current collector preferably extend parallel to the respective longitudinal edges of the current collectors. Preferably, the strip-shaped main regions extend over at least 90%, particularly preferably over at least 95%, of the surfaces of the anode current collector and the cathode current collector.

In some preferred embodiments, the support material is applied adjacent to the strip-shaped main regions, but does not completely cover the free regions. For example, it is applied in the form of a strip or a line along a longitudinal edge of the anode and/or cathode current collector, so that it only partially covers the respective edge strip. Directly along this longitudinal edge, an elongated part of the free edge strip can remain uncovered.

Particularly preferably, the lithium ion cell according to the first aspect of the disclosure is a secondary lithium ion cell. Basically all electrode materials known for lithium ion cells can be used for their anode and cathode.

In the negative electrode, carbon-based particles such as graphitic carbon or non-graphitic carbon materials capable of intercalating lithium, preferably also in particle form, are preferably used as active materials. Alternatively or additionally lithium titanate (Li₄Ti₅O₁₂) and also metallic and semi-metallic materials that are alloyable with lithium can be used, for example the elements tin, antimony and silicon, which are capable of forming intermetallic phases with lithium. These materials are also preferably used in particle form. For the positive electrode, lithium metal oxide compounds and lithium metal phosphate compounds such as LiCoO₂ and LiFePO₄ can be considered as active materials. Furthermore, lithium nickel manganese cobalt oxide (NMC) with the chemical formula LiNiₓMn_{y}Co_{z}O₂ (where x+y+z is typically 1), lithium manganese spinel (LMO) with the chemical formula LiMn₂O₄, or lithium nickel cobalt aluminium oxide (NCA) with the chemical formula LiNiₓCo_{y}Al_{z}O₂ (where x+y+z is typically 1) are particularly suitable. Derivatives thereof, for example lithium nickel manganese cobalt alumina (NMCA) with the chemical formula Li_{1.11}(Ni_{0.40}Mn_{0.39}Co_{0.16}Al_{0.05})_{0.89}O₂ or Li₁₊ₓM-O compounds and/or mixtures of the materials mentioned can also be used.

As electrochemically inactive components, the electrode materials may contain, for example, an electrode binder and a conductive agent. The particulate active materials are preferably embedded in a matrix of the electrode binder, with adjacent particles in the matrix preferably being in direct contact with each other. Conductive agents have the function of increasing the electrical conductivity of the electrodes. Common electrode binders are based, for example, on polyvinylidene fluoride, polyacrylate or carboxymethyl cellulose. Common conductive agents are carbon black and metal powder.

Furthermore, the cell preferably comprises an electrolyte, in particular based on at least one lithium salt such as lithium hexafluorophosphate, which is dissolved in an organic solvent (e.g. in a mixture of organic carbonates).

The separator is, for example, an electrically insulating plastic film that can be penetrated by the electrolyte, for example because it has micropores. The film can be made of a polyolefin or a polyetherketone, for example. Fleeces and fabrics made of such plastic materials can also be used as separators.

In the manufacture of electrode-separator assemblies, care is usually taken to ensure that oppositely poled current collectors do not protrude from one side, as this can increase the risk of short circuits. In the arrangement of anode and cathode described above, however, the risk of short circuits is minimised because the current collectors with opposite polarity protrude from opposite end faces of the winding or stack.

The protrusion of the current collectors resulting from this arrangement can be utilised by contacting them preferably over their entire length by means of a corresponding current conductor. The aforementioned contact sheet metal member serves as a current conductor. Such an electrical contacting reduces the internal resistance within the cell significantly. The arrangement described can thus absorb the occurrence of large currents very well. With minimised internal resistance, thermal losses at high currents are reduced. In addition, the dissipation of thermal energy from the wound electrode-separator assembly is facilitated. In the case of heavy loads, heating does not occur locally but evenly distributed.

The housing of the lithium ion cell according to the first aspect of the disclosure preferably encloses the electrode-separator assembly or the stack of identical electrode-separator assemblies in a gas-tight and/or liquid-tight manner.

When contact sheet metal members are used, it is generally necessary to electrically connect the contact sheet metal members to the housing or to electrical conductors that are led out of the housing. For example, the contact sheet metal members can be connected to the mentioned housing parts directly or via electrical conductors.

If the electrode-separator assembly is part of the stack of two or more identical electrode-separator assemblies, the identical electrode-separator assemblies are arranged within the stack such that the longitudinal edges of their anode current collectors and the longitudinal edges of their cathode current collectors protrude from the same side of the stack. In this way, all anode current collectors and all cathode current collectors can be electrically contacted simultaneously with the same contact sheet metal member.

In embodiments, the cell according to the first aspect of the disclosure includes the immediately following feature j:

j. a part of the housing serves as the contact sheet metal member and/or the contact sheet metal member forms a part of the housing which encloses the electrode-separator assembly.

This design is particularly advantageous. On the one hand, it is optimal from a heat dissipation point of view. Heat generated within the winding can be dissipated directly to the housing via the longitudinal edges. On the other hand, the internal volume of a housing with given external dimensions can be utilised almost optimally in this way. Each separate contact sheet metal member and each separate electrical conductor for connecting the contact sheet metal members to the housing requires space within the housing and contributes to the weight of the cell. If such separate components are dispensed with, this space is available for active material. In this way, the energy density can be further increased.

In a first variant, the cell according to the first aspect of the disclosure includes at least one of the immediately following features a. and b., particularly preferably by a combination of the two features:

a. The housing comprises a cup-shaped first housing part having a bottom and a circumferential side wall and an opening, and a second housing part closing the opening.

b. The contact sheet metal member is the bottom of the first housing part.

The housing is preferably cylindrical or prismatic. The cup-shaped first housing part preferably has a circular or rectangular cross-section and the second housing part and the bottom of the first housing part are preferably circular or rectangular.

If the electrode-separator assembly is in the form of the winding with the two terminal end faces, the housing is preferably cylindrical. If the electrode-separator assembly is part of the stack of two or more identical electrode-separator assemblies, the housing is preferably prismatic.

If the housing is cylindrical, it generally comprises a cylindrical housing shell as well as a circular upper part and a circular lower part, whereby in this variant the first housing part comprises the housing shell and the circular lower part while the second housing part corresponds to the circular upper part. The circular upper part and/or the circular lower part can serve as contact sheet metal members.

If the housing is prismatic, then the housing generally comprises several rectangular side walls as well as a polygonal, in particular rectangular upper part and a polygonal, in particular rectangular lower part, whereby in this variant the first housing part comprises the side walls and the polygonal lower part while the second housing part corresponds to the circular polygonal upper part. The upper part and/or the lower part can serve as contact sheet metal parts.

Both the first and the second housing part preferably consist of an electrically conductive material, in particular a metallic material. The housing parts can, for example, consist of a nickel-plated sheet steel or of alloyed or unalloyed aluminium.

In a preferred further development of the first variant, the cell includes at least one of the immediately following features a. to e., in particular, a combination of the immediately following features a. to e.:

a. The cell has a contact sheet metal member with which the first longitudinal edge of the anode current collector is in direct contact, preferably longitudinally, and to which this longitudinal edge is connected by welding.

b. The cell has a contact sheet metal member with which the first longitudinal edge of the cathode current collector, preferably longitudinally, is in direct contact with and to which this longitudinal edge is connected by welding.

c. One of the contact sheet metal members is the bottom of the first housing part.

d. The other of the contact sheet metal members is connected to the second housing part by an electrical conductor.

e. The cell comprises a seal which electrically isolates the first and second housing parts from each other.

In this embodiment, conventional housing parts can be used to enclose the electrode-separator assembly. No space is wasted for electrical conductors which are placed between the bottom and the electrode-separator assembly. A separate contact sheet metal member is not required at the bottom. To close the housing, the electrically insulating seal can be fitted to one edge of the second housing part. The assembly of the second housing part and the seal can be inserted into the opening of the first housing part and mechanically fixed there, for example by means of a crimping process.

In a particularly preferred embodiment of the first variant, the second housing part can also serve as a contact sheet metal member. In this embodiment, the cell includes at least one of the immediately following features a. to e., in particular by a combination of the immediately following features a. to e.

a. The cell has a contact sheet metal member with which the first longitudinal edge of the anode current collector is in direct contact, preferably longitudinally, and to which this longitudinal edge is connected by welding.

b. The cell has a contact sheet metal member with which the first longitudinal edge of the cathode current collector, preferably longitudinally, is in direct contact with and to which this longitudinal edge is connected by welding.

c. One of the contact sheet metal members is the bottom of the first housing part.

d. The other of the contact sheet metal members is the second housing part.

e. The cell comprises an electrical seal which electrically isolates the first and second housing parts from each other.

In this embodiment, electrical conductors are not required on either side of the electrode-separator assembly to connect contact sheet metal members to housing parts. On one side, one of the contact sheet metal members has the additional function of a housing part, on the other side, a part of a housing serves as a contact sheet metal member. The space inside the housing can be used optimally.

In a further preferred development of the first variant, the cell includes at least one of the immediately following features a. to e.:

a. The cell has a contact sheet metal member with which the first longitudinal edge of the anode current collector is in direct contact, preferably longitudinally, and to which this longitudinal edge is connected by welding.

b. The cell has a contact sheet metal member with which the first longitudinal edge of the cathode current collector, preferably longitudinally, is in direct contact with and to which this longitudinal edge is connected by welding.

c. One of the contact sheet metal members is the bottom of the first housing part.

d. The second housing part is welded into the opening of the first housing part and comprises a pole bushing, for example a pole stud surrounded by an electrical insulator, through which an electrical conductor is led out of the housing.

e. The other of the contact sheet metal members is electrically connected to this electrical conductor.

It is particularly preferred that the immediately preceding features a. to e. are realized in combination with each other.

In this embodiment, the housing parts are welded together and thus electrically connected. For this reason, said pole bushing is required.

In a second variant, the cell according to the first aspect of the disclosure includes at least one of the immediately following features a. and b., particularly preferably a combination of the two features:

a. The housing comprises a tubular first housing part with two terminal openings, a second housing part closing one of the openings and a third housing part closing the other of the openings.

b. The contact sheet metal member is the second housing part or the third housing part.

In this variant, too, the housing of the cell is preferably cylindrical or prismatic. The tubular first housing part preferably has a circular or rectangular cross-section and the second and third housing parts are preferably circular or rectangular.

If the housing is cylindrical, then the first housing part is generally hollow cylindrical, while the second and third housing parts are circular and can serve as contact sheet metal members and simultaneously as a bottom and lid, which can close the first housing part completely.

If the housing is prismatic, the first housing part generally comprises several rectangular side walls connected to each other by common edges, while the second and third housing parts are each polygonal, in particular rectangular. Both the second and third housing parts can serve as contact sheet metal members.

Both the first and the second housing part preferably consist of an electrically conductive material, in particular a metallic material. The housing parts can consist of, for example, a nickel-plated steel sheet, stainless steel (for example type 1.4303 or 1.4304), copper, nickel-plated copper or alloyed or unalloyed aluminium. It may also be preferred that housing parts electrically connected to the cathode consist of aluminium or an aluminium alloy and housing parts electrically connected to the anode consist of copper or a copper alloy or nickel-plated copper.

A major advantage of this variant is that no cup-shaped housing parts are required for the housing which have to be manufactured by upstream forming and/or casting processes. Instead, the tubular first housing part serves as the starting point.

In a preferred further development of the second variant, the cell includes at least one of the immediately following features a. to e., in particular by a combination of the immediately following features a. to e.:

a. The cell has a contact sheet metal member with which the first longitudinal edge of the anode current collector is in direct contact, preferably longitudinally, and to which this longitudinal edge is connected by welding.

b. The cell has a contact sheet metal member with which the first longitudinal edge of the cathode current collector is in direct contact with, preferably longitudinally, and to which this longitudinal edge is connected by welding.

c. One of the contact sheet metal members is welded into one of the terminal openings of the first housing part and is the second housing part.

d. The third housing part is welded into the other of the terminal openings of the first housing part and comprises a pole bushing through which an electrical conductor is led out of the housing, for example a pole stud surrounded by an electrical insulator.

e. The other of the contact sheet metal members is electrically connected to this electrical conductor.

It is particularly preferred that the immediately preceding features a. to e. are realized in combination with each other.

In a further preferred further development of the second variant, the cell includes at least one of the immediately following features a. to d.:

a. The cell has a contact sheet metal member with which the first longitudinal edge of the anode current collector is in direct contact, preferably longitudinally, and to which this longitudinal edge is connected by welding.

b. The cell has a contact sheet metal member with which the first longitudinal edge of the cathode current collector, preferably longitudinally, is in direct contact with and to which this longitudinal edge is connected by welding.

c. One of the contact sheet metal members is welded into one of the terminal openings of the first housing part and is the second housing part.

d. The other of the contact sheet metal members is a third housing part which closes the other of the end openings of the first housing part and is insulated from the first housing part by means of a seal.

It is particularly preferred that the immediately preceding features a. to d. are realized in combination with each other.

Both embodiments are characterised by the fact that on one housing side a contact sheet metal member serves as a housing part and is connected to the first housing part by welding. On the other side, a contact sheet metal member can also serve as a housing part. However, this must then be electrically insulated from the first housing part. Alternatively, a pole bushing can be used here as well.

The pole bushings can comprise an electrical insulator which prevents electrical contact between the housing and the electrical conductor led out of the housing. The electrical insulator can be, for example, a glass or a ceramic material or a plastic.

The electrode-separator assembly is preferably in the form of a cylindrical winding. Providing the electrodes in the form of such a winding allows particularly advantageous use of space in cylindrical housings. Therefore, in preferred embodiments, the housing is also cylindrical.

In other preferred embodiments, the electrode-separator assembly is preferably in the form of a prismatic winding. Providing the electrodes in the form of such a winding allows particularly advantageous use of space in prismatic housings. In preferred embodiments, the housing is therefore also prismatic.

In addition, prismatic housings can be filled particularly well by prismatic stacks of the identical electrode-separator assemblies introduced above. For this purpose, the electrode-separator assemblies may particularly preferably have a substantially rectangular shape.

In particularly preferred embodiments, the cell according to the first aspect of the disclosure includes at least one of the immediately following features a. to c.:

a. The strip-shaped main region of the current collector connected to the contact sheet metal member by welding has a plurality of apertures.

b. The apertures in the main region are round or angular holes, in particular punched or drilled holes.

c. The current collector which is connected to the contact sheet metal member by welding is perforated in the main area, in particular by round holes or slotted holes.

The large number of apertures results in a reduced volume and also reduced weight of the current collector. This makes it possible to introduce more active material into the cell and in this way drastically increase the energy density of the cell. Energy density increases up to the double-digit percentage range can be achieved in this way.

In some preferred embodiments, the apertures are introduced into the strip-shaped main region by means of a laser.

In principle, the geometry of the apertures is not essential. What is important is that as a result of the insertion of the apertures, the mass of the current collector is reduced and there is more space for active material, since the apertures can be filled with the active material.

On the other hand, it can be advantageous to ensure that the maximum diameter of the apertures is not too large when inserting the apertures. Preferably, the apertures should not be more than twice the thickness of the layer of electrode material on the respective current collector.

In particularly preferred embodiments, the cell according to the first aspect of the disclosure includes the following feature a. immediately below:

a. The apertures in the current collector, in particular in the main region, have diameters in the range from 1 μm to 3000 μm.

Within this preferred range, diameters in the range from 10 μm to 2000 μm, preferably from 10 μm to 1000 μm, in particular from 50 μm to 250 μm, are further preferred.

Particularly preferably, the cell according to the first aspect of the disclosure includes at least one of the immediately following features a. and b:

a. The current collector which is connected to the contact sheet metal member by welding has, at least in a partial section of the main area, a lower weight per unit area than the free edge strip of the same current collector.

b. The current collector which is connected to the contact sheet metal member by welding has no or fewer apertures per unit area in the free edge strip than in the main area.

It is particularly preferred that the immediately preceding features a. and b. are realized in combination with each other.

The free edge strips of the anode and cathode current collector delimit the main area towards the first longitudinal edges. Preferably, the anode and cathode current collectors comprise free edge strips along their longitudinal edges.

The apertures characterise the main region. In other words, the boundary between the main region and the free edge strip(s) corresponds to a transition between regions with and without apertures.

The apertures are preferably distributed substantially evenly over the main area.

In further particularly preferred embodiments, the cell according to the first aspect of the disclosure includes at least one of the immediately following features a. to c.:

a. The weight per unit area of the current collector in the main area is reduced by 5% to 80% compared to the weight per unit area of the current collector in the free edge strip.

b. The current collector has a perforated area in the range of 5% to 80% in the main area.

c. The current collector has a tensile strength in the main area of 20 N/mm² to 250 N/mm².

The hole area, often referred to as the free cross-section, can be determined according to ISO 7806-1983. The tensile strength of the current collector in the main area is reduced compared to current collectors without the apertures. It can be determined according to DIN EN ISO 527 part 3.

It is preferred that the anode current collector and the cathode current collector have the same or similar apertures. The respective achievable energy density improvements add up. In preferred embodiments, the cell according to the first aspect of the disclosure includes at least one of the immediately following features a. to c.:

a. The strip-shaped main region of the anode current collector and the strip-shaped main region of the cathode current collector are both characterised by a plurality of apertures.

b. The cell comprises the contact sheet metal member resting on one of the first longitudinal edges as the first contact sheet metal member, and further comprises a second contact sheet metal member resting on the other of the first longitudinal edges.

c. The second contact sheet metal member is connected to this other longitudinal edge by welding.

It is particularly preferred that the immediately preceding features a. to c. are realized in combination with each other. However, features b. and c. can also be implemented in combination without feature a.

The preferred embodiments of the apertured current collector described above are independently applicable to the anode current collector and the cathode current collector.

The use of perforated or otherwise apertured current collectors has not been seriously considered for lithium ion cells, since it is very difficult to contact such current collectors electrically. As mentioned at the beginning, the electrical connection of the current collectors is often made via separate electrical conductor tabs. However, reliable welding of these conductor tabs to perforated current collectors in industrial mass production processes is difficult to realize without an acceptable error rate.

According to the disclosure, this problem is solved by welding the current collector edges to the contact sheet metal member(s) as described. The concept according to the disclosure makes it possible to completely dispense with separate conductor tabs and thus enables the use of current collectors with a low material content and provided with apertures. In particular, in embodiments in which the free edge strips of the current collectors are not provided with apertures, welding can be carried out reliably with extremely low reject rates.

If very thin metal foils are used as current collectors, the longitudinal edges of the current collectors can be extremely sensitive mechanically and can be unintentionally pressed down or melted down during welding to the contact sheet metal member(s). Furthermore, during welding of the contact sheet metal members, separators of the electrode-separator assembly may melt. The support layer described above counteracts this.

The concept of welding the edges of current collectors with contact sheet metal members is already known from WO 2017/215900 A1 or from JP 2004-119330 A. The use of contact sheet metal members enables particularly high current carrying capacities and low internal resistance. With regard to methods for electrically connecting contact sheet metal members to the edges of current collectors, full reference is therefore made to the contents of WO 2017/215900 A1 and JP 2004-119330 A.

The contact sheet metal members which are preferably usable may also be referred to as contact plates. In preferred embodiments, they are plate-shaped.

In some preferred embodiments, the cell according to the first aspect of the disclosure has at least one of the following features a. and b. immediately below:

a. Contact sheet metal members, in particular contact plates, having a thickness in the range of 50 μm to 600 μm, preferably 150-350 μm.

b. The contact sheet metal members, in particular the contact plates, consist of alloyed or unalloyed aluminium, titanium, nickel or copper, but optionally also of stainless steel (for example of type 1.4303 or 1.4304) or of nickel-plated steel.

The specified thicknesses are preferred both in the described cases in which a contact sheet metal member, in particular a contact plate, is part of the housing and in cases in which a contact sheet metal member, in particular a contact plate, does not serve as part of the housing.

In particular, in embodiments where a contact sheet metal member, in particular a contact plate, does not serve as part of the housing, it may comprise at least one slot and/or at least one perforation. These have the function of counteracting deformation of the contact sheet metal member, in particular the contact plate, during the production of the welded joint.

In particular, in embodiments in which a contact sheet metal member, especially a contact plate, serves as part of the housing, slits and perforations are preferably omitted. However, such a contact sheet metal member, in particular such a contact plate, may have an aperture, in particular a hole in a central area.

In cases where the housing is cylindrical, contact sheet metal members, in particular contact plates, are preferably used which have the shape of a disc, in particular the shape of a circular or at least approximately circular disc. They then have an outer circular or at least approximately circular disc edge. By an approximately circular disc is meant in particular a disc which has the shape of a circle with at least one cut off circular segment, preferably with two to four cut off circular segments.

In cases where the housing is prismatic, contact sheet metal members, in particular contact plates, are preferably used which have a polygonal, in particular a rectangular basic shape.

In particularly preferred embodiments, the anode current collector and the contact sheet metal member welded thereto, in particular the contact plate welded thereto, both consist of the same material. This is particularly preferably selected from the group comprising copper, nickel, titanium, nickel-plated steel and stainless steel.

In further particularly preferred embodiments, the cathode current collector and the contact sheet metal member welded thereto, in particular the contact plate welded thereto, both consist of the same material. This is particularly preferably selected from the group comprising alloyed or unalloyed aluminium, titanium and stainless steel (e.g. of type 1.4404).

As mentioned above, the cell according to the first aspect of the disclosure has a contact sheet metal member, in particular a contact plate metal member, with which one of the first longitudinal edges, preferably longitudinally, is in direct contact with. This can result in a line-shaped contact zone.

In possible preferred further developments, the cell according to the first aspect of the disclosure includes at least one of the immediately following features a. to c.:

a. The first longitudinal edge of the anode current collector is in direct contact with a contact sheet metal member, in particular a contact metal plate, preferably longitudinally, and is connected to this contact sheet metal member, in particular this contact plate, by welding, wherein a line-shaped contact zone consists of between the longitudinal edge and the contact sheet metal member, in particular the contact metal plate.

b. The first longitudinal edge of the cathode current collector is in direct contact with a contact sheet metal member, in particular a metallic contact plate, preferably longitudinally, and is connected to this contact sheet metal member, in particular this contact plate, by welding, wherein a line-shaped contact zone consists of between the longitudinal edge and the contact sheet metal member, in particular the metallic contact plate.

c. The first longitudinal edge of the anode current collector and/or of the cathode current collector comprises one or more sections which are each connected continuously over their entire length by a weld seam to the respective contact sheet metal member, in particular to the respective contact plate.

The immediately preceding features a. and b. can be realized both independently of each other and in combination. Preferably, however, features a. and b. are realized in both cases in combination with the immediately preceding feature c.

There are several ways in which the contact sheet metal members, in particular the contact plates, can be connected to the longitudinal edges.

The contact sheet metal members may be connected to the longitudinal edges along the line-shaped contact zones by at least one weld seam. The longitudinal edges can thus comprise one or more sections, each of which is continuously connected to the contact sheet metal member(s) over its entire length via a weld seam. Particularly preferably, these sections have a minimum length of 5 mm, preferably of 10 mm, particularly preferably of 20 mm.

In a possible further development, the section or sections continuously connected to the contact sheet metal member over their entire length extend over at least 25%, preferably over at least 50%, particularly preferably over at least 75%, of the total length of the respective longitudinal edge.

In some preferred embodiments, the longitudinal edges are continuously welded to the contact sheet metal member, in particular the contact plate, over their entire length.

In further possible embodiments, the contact sheet metal members, in particular the contact plates, are connected to the respective longitudinal edge via a plurality or multiple welding spots.

If the electrode-separator assembly is in the form of a spiral winding, the longitudinal edges of the anode current collector and the cathode current collector protruding from the terminal end faces of the winding generally also have a spiral geometry. The same applies to the line-shaped contact zone along which the contact sheet metal members, in particular the contact plates, are welded to the respective longitudinal edge.

If the electrode-separator assembly is part of the stack of the two or more identical electrode-separator assemblies, the longitudinal edges of the anode current collector and the cathode current collector protruding from the terminal sides of the winding generally have a linear geometry. The same applies to the line-shaped contact zone along which the contact sheet metal members, in particular the contact plates, are welded to the respective longitudinal edge.

In further possible preferred further developments, the cell according to the first aspect of the disclosure includes at least one of the immediately following features a. to c.:

a. The separator is a ribbon-shaped plastic substrate having a thickness in the range of from 5 μm to 50 μm, preferably in the range of from 7 μm to 12 μm, and having a first and a second longitudinal edge and two ends.

b. The longitudinal edges of the separator form the terminal sides or end faces of the electrode-separator composite.

c. The longitudinal edges of the anode current collector and/or the cathode current collector protruding from the terminal sides or end faces of the winding do not exceed 5000 μm, preferably not exceed 3500 μm.

It is particularly preferred that the immediately preceding features a. to c. are realized in combination with each other.

Particularly preferably, the longitudinal edge of the anode current collector protrudes from the side or end face of the winding no more than 2500 μm, especially preferably no more than 1500 μm.

Particularly preferably, the longitudinal edge of the cathode current collector protrudes from the side or end face of the winding no more than 3500 μm, especially preferably no more than 2500 μm.

The figures for the projection of the anode current collector and/or the cathode current collector refer to the free projection before the sides or end faces are brought into contact with the contact plate. When contacting and welding on the contact sheet metal member, in particular the contact plate, deformation of the edges of the current collectors may occur.

The smaller the free protrusion is selected, the wider the ribbon-shaped main areas of the current collectors covered with electrode material can be formed. This can contribute positively to the energy density of the cell.

Preferably, the ribbon-shaped anode and the ribbon-shaped cathode are offset from each other within the electrode-separator assembly to ensure that the first longitudinal edge of the anode current collector protrudes from one of the terminal end faces and the first longitudinal edge of the cathode current collector protrudes from the other of the terminal end faces.

The lithium ion cell according to the first aspect of the disclosure may be a button cell. Button cells are cylindrical and have a height that is less than their diameter. Preferably, the height is in the range of 4 mm to 15 mm. It is further preferred that the cell has a diameter in the range of 5 mm to 25 mm. Button cells are suitable, for example, for supplying small electronic devices such as watches, hearing aids and wireless headphones with electrical energy.

The nominal capacity of a lithium ion cell according to the first aspect of the disclosure in the form of a button cell is generally up to 1500 mAh. Preferably, the nominal capacity is in the range of 100 mAh to 1000 mAh, particularly preferably in the range of 100 to 800 mAh.

Particularly preferably, the lithium ion cell according to the first aspect of the disclosure is a cylindrical round cell. Cylindrical round cells have a height that is greater than their diameter. They are particularly suitable for applications in the automotive sector, for e-bikes or also for other applications with high energy requirements.

Preferably, the height of lithium ion cells designed as round cells is in the range of 15 mm to 150 mm. The diameter of the cylindrical round cells is preferably in the range of 10 mm to 60 mm. Within these ranges, form factors of, for example, 18×65 (diameter*height in mm) or 21×70 (diameter*height in mm) are particularly preferred. Cylindrical round cells with these form factors are particularly suitable for supplying power to electric drives in motor vehicles.

The nominal capacity of the lithium ion cell according to the first aspect of the disclosure in the form of a cylindrical round cell is preferably up to 90000 mAh. With the form factor of 21×70, the cell in one embodiment as a lithium ion cell preferably has a nominal capacity in the range of 1500 mAh to 7000 mAh, particularly preferably in the range of 3000 to 5500 mAh. With the form factor of 18×65, the cell in one embodiment as a lithium ion cell preferably has a nominal capacity in the range of 1000 mAh to 5000 mAh, particularly preferably in the range of 2000 to 4000 mAh.

In the European Union, manufacturers' specifications regarding the nominal capacities of secondary batteries are strictly regulated. For example, information on the nominal capacity of secondary nickel-cadmium batteries must be based on measurements according to the IEC/EN 61951-1 and IEC/EN 60622 standards, information on the nominal capacity of secondary nickel-metal hydride batteries must be based on measurements according to the IEC/EN 61951-2 standard, information on the nominal capacity of secondary lithium batteries must be based on measurements according to the IEC/EN 61960 standard and information on the nominal capacity of secondary lead-acid batteries must be based on measurements according to the IEC/EN 61056-1 standard. Any indications of nominal capacities in the present application are preferably also based on these standards.

In embodiments in which the cell according to the first aspect of the disclosure is a cylindrical round cell, the anode current collector, the cathode current collector and the separator preferably have the following dimensions:

A length in the range of 0.5 m to 25 m

A width in the range of 30 mm to 145 mm

The free edge strip which extends along the first longitudinal edge and which is not loaded with the electrode material preferably has in these cases a width of not more than 5000 μm.

In the case of a cylindrical round cell with a form factor of 18×65, the current collectors preferably have:

a width of 56 mm to 62 mm, preferably 60 mm, and

a length of no more than 1.5 m.

In the case of a cylindrical round cell with a form factor of 21×70, the current collectors preferably have:

a width of 56 mm to 68 mm, preferably 65 mm, and

a length of no more than 2.5 m.

The above-described design of the cell according to the first aspect of the disclosure enables yet another significant advantage. In the case of electrodes in which the current collectors are electrically connected via the separate conductor tabs mentioned at the beginning, a greater thermo-mechanical load occurs during charging and discharging in the immediate vicinity of the conductor tabs than away from the conductor tabs. This difference is particularly pronounced with negative electrodes that have a proportion of silicon, tin and/or antimony as the active material, as particles made of these materials are subject to comparatively strong volume changes during charging and discharging. For example, proportions of more than 10% silicon in negative electrodes have so far proved difficult to control.

The electrical connection of the current collector(s) via contact sheet metal members not only enables the aforementioned uniform heat dissipation of cells, but also distributes the thermo-mechanical loads occurring during charging and discharging evenly over the winding. Surprisingly, this makes it possible to control very high proportions of silicon and/or tin and/or antimony in the negative electrode. With proportions >20%, comparatively rare or no damage was observed during charging and discharging as a result of the thermomechanical stresses. By increasing the proportion of, for example, silicon in the anode, the energy density of the cell can also be further increased.

Accordingly, in particularly preferred embodiments, the cell according to the first aspect of the disclosure includes the immediately following feature a:

a. The negative electrode material comprises as negative active material silicon, aluminium, tin and/or antimony, in particular particulate silicon, aluminium, tin and/or antimony, in a proportion of from 20% by weight to 90% by weight, preferably from 50% by weight to 90% by weight.

The weight specifications here refer to the dry mass of the negative electrode material, i.e. without electrolyte and without taking into account the weight of the anode current collector.

It should be emphasised that this embodiment can also be realized completely independently of feature k. (k. a part of the housing serves as the contact sheet metal member and/or the contact sheet metal member forms a part of the housing enclosing the electrode-separator assembly). The first aspect of the disclosure thus also comprises cells in which the anode in the charged state comprises particulate silicon in a proportion of 20 wt. % to 90 wt. %, but in which part of the housing does not necessarily serve as the contact sheet metal member and/or the contact sheet metal member forms part of the housing enclosing the electrode-separator assembly.

Of the active materials silicon, aluminium, tin and antimony, silicon is particularly preferred.

The skilled person understands that the tin, aluminium, silicon and antimon are not necessarily metals in their purest form. For example, silicon particles may also contain traces of other elements, in particular other metals (apart from lithium), for example in proportions of up to 10% by weight.

According to a second aspect, the disclosure provides a method of manufacturing a cell, the method including the immediately following steps or features a. to d.:

a. Providing the electrode-separator assembly described above with the terminal sides or end faces from which the first longitudinal edge of the anode current collector and the first longitudinal edge of the cathode current collector protrude,

b. Providing one of the contact sheet metal members described above for electrically contacting one of the first longitudinal edges,

c. Welding this longitudinal edge to the contact sheet metal member,

wherein

d. a part of a housing part which encloses the electrode-separator assembly serves as the contact sheet metal member, or the contact sheet metal member is connected to at least one further housing part to form a housing which encloses the electrode-separator assembly.

The contact sheet metal member is thus provided as part of a housing part, if applicable.

Both alternatives comprised by the immediately preceding feature d. have advantages, which will be discussed below.

In a first, particularly preferred further development of the method according to the second aspect of the disclosure, the method comprises at least one further of the immediately following additional steps and/or one of the immediately following features a. to d.:

a. A cup-shaped shaped first housing part having a bottom and a circumferential side wall and an opening is provided.

b. The electrode-separator assembly is inserted into the cup-shaped housing until the first longitudinal edge of the anode current collector or the first longitudinal edge of the cathode current collector is in direct contact with the bottom.

c. Welding this longitudinal edge to the bottom of the first housing part.

d. Closing the opening of the first housing part with a second, preferably circular housing part.

Preferably, the method comprises a combination of the four steps and/or features a. to d. immediately above.

In this further development, the bottom of the first housing part serves as a contact sheet metal member.

With regard to possible preferred designs of the contact sheet metal member as well as the first cup-shaped and the second housing part, reference is made to the above explanations of the cell according to the first aspect of the disclosure.

The welding of the longitudinal edge to the bottom of the first housing part can be carried out in particular by means of a laser from outside the housing.

In this first further development, it is preferred that the first longitudinal edge of the anode or cathode current collector, which is not in contact with the bottom, is already welded to a further contact sheet metal member when the electrode-separator assembly is inserted into the cup-shaped first housing. This further contact sheet metal member can be connected to the second housing part via an electrical conductor, which serves to close the opening of the cup-shaped first housing part.

In these cases, where the further contact sheet metal member is connected to the second housing part via the electrical conductor, the second housing part is preferably welded into the opening of the first housing part, for example by means of a laser. In these cases, the second housing part preferably has the pole bushing described above. Alternatively, it is also possible to apply an electrically insulating seal to the edge of the second housing part, insert the second housing part together with the seal into the opening of the first housing part and fix it there.

In another embodiment of the first further development, the further contact sheet metal member serves as a housing part which is connected to the cup-shaped first housing part to form the housing enclosing the electrode-separator assembly, more precise, as the second housing part of the immediately preceding feature d.

In this case, the further contact sheet metal member already welded to the longitudinal edge of the anode or cathode current collector is preferably mechanically fixed, for example by means of a crimping process, after insertion to close the housing in the opening of the first housing part, Before this, an electrically insulating seal must be applied to the edge of the contact sheet metal member. This is ideally done before the electrode-separator assembly is inserted into the first housing part.

This embodiment has the charm that the dead volume inside the housing is minimised by the bifunctionality of the contact sheet metal members, which are both housing parts at the same time.

In a second, particularly preferred further development of the method, the method comprises at least one of the immediately following additional steps and/or one of the immediately following features:

a. The electrode-separator assembly is provided.

b. A contact sheet metal member, in particular a metal contact plate, is brought into direct contact with the first longitudinal edge of the anode current collector and is welded to this longitudinal edge.

c. A contact sheet metal member, in particular a metallic contact plate, is brought directly into contact with the first longitudinal edge of the cathode current collector and welded to this longitudinal edge.

d. A tubular first housing part with two end face openings is provided.

e. The electrode-separator assembly is inserted into the tubular first housing part through one of the end-face openings.

f. One of the contact sheet metal members, in particular one of the contact plates, is welded into one of the end faces of the first housing part as a second housing part.

g. A third housing part, which comprises a pole bushing through which an electrical conductor can be led out of the housing, for example a pole stud surrounded by an electrical insulator, is welded into the other of the end faces of the first housing part.

Preferably, the method comprises a combination of the seven steps and/or features a. to g. immediately above.

With regard to possible preferred designs of the first cup-shaped and the second housing part, reference is also made here to the above explanations of the cell according to the first aspect of the disclosure.

This embodiment has the charm that the tubular first housing part is easier and cheaper to produce than a cup-shaped housing part.

The first housing part is preferably welded to the second housing part by means of a laser.

It is preferred that the method according to the second aspect of the disclosure includes at least one of the following immediate additional steps and/or features a. orb:

a. The housing is filled with an electrolyte through a hole in one of the housing parts.

b. The hole is closed after filling by welding, gluing, riveting or soldering.

The hole can be located, for example, in the bottom of the first cup-shaped housing part or it forms an aperture in one of the other housing parts, possibly in one of the contact sheet metal parts.

In a particularly preferred embodiment, the hole is closed by means of a pressure relief valve, for example in the form of a bursting cross.

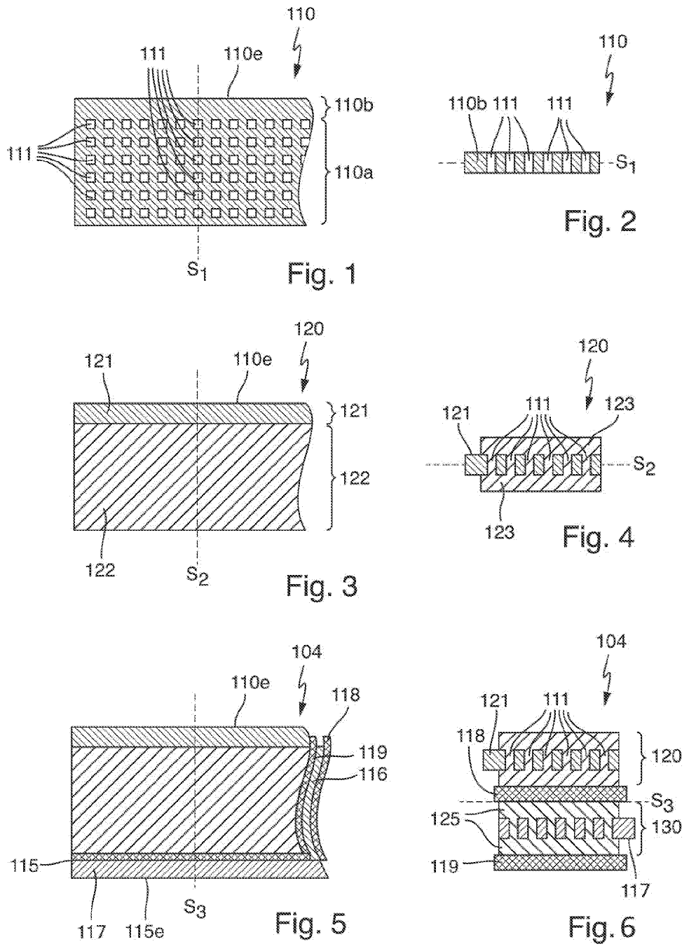

FIG. 1 and FIG. 2 illustrate the design of a current collector 110 that can be used in a cell according to the disclosure. FIG. 2 is a sectional view along S₁. The current collector 110 comprises a plurality of apertures 111, which are rectangular holes. The region 110a is characterised by the apertures 111, whereas there are no apertures in the region 110b along the longitudinal edge 110e. The current collector 110 therefore has a significantly lower weight per unit area in the area 110a than in the area 110b.

FIG. 3 and FIG. 4 illustrate an anode 120 made by applying a negative electrode material 123 to both sides of the current collector 110 shown in FIG. 2 and FIG. 3. FIG. 5 is a section along S₂. The current collector 110 now has a strip-shaped main region 122, which is loaded with a layer of the negative electrode material 123, and a free edge strip 121, which extends along the longitudinal edge 110e and which is not loaded with the electrode material 123. The electrode material 123 also fills the apertures 111.

FIG. 5 and FIG. 6 illustrate an electrode-separator assembly 104 made using the anode 120 shown in FIG. 4 and FIG. 5. It also comprises the cathode 115 and the separators 118 and 119. FIG. 6 is a sectional view along S₃. The cathode 115 is based on the same current collector design as the anode 120. Preferably, the current collectors 110 and 115 of anode 120 and cathode 130 differ only in their respective choice of materials. Thus, the current collector 115 of the cathode 130 comprises a strip-shaped main region 116 loaded with a layer of positive electrode material 125 and a free edge strip 117 extending along the longitudinal edge 115e which is not loaded with the electrode material 125. By spirally winding, the electrode-separator assembly 104 can be transformed into a winding such as may be included in a cell.

In some preferred embodiments, the free edge strips 117 and 121 are coated on both sides and at least in some areas with one of the support materials described above.

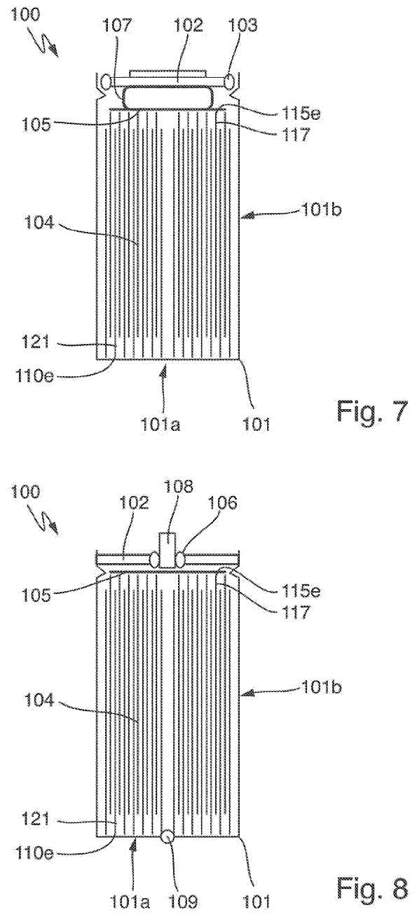

FIG. 7 shows a cell 100 with a housing comprising a first housing part 101 and a second housing part 102. The electrode-separator assembly 104 is enclosed in the housing. The housing is generally cylindrical in shape, the housing part 101 having a circular bottom 101a, a hollow cylindrical shell 101b and a circular opening opposite the bottom 101a. The housing part 102 serves to close the circular opening and is formed as a circular lid. The electrode-separator assembly 104 is in the form of a cylindrical winding with two terminal end faces.

In the case of prismatic housings, a section through the cell could look exactly the same. The housing part 101 in this case would have a rectangular bottom 101a, a rectangular side wall 101b and a rectangular cross-section as well as a rectangular opening, the housing part 102 would be formed as a rectangular lid to close the rectangular opening. And the reference sign 104 in this case would not denote an electrode-separator assembly in cylindrical form but a stack of several identical electrode-separator assemblies or a prismatic winding.

The free edge strip 121 of an anode current collector 110 protrudes from one end face of the electrode-separator assembly 104, and the free edge strip 117 of a cathode current collector 115 protrudes from the other end face. The edge 110e of the anode current collector 110 is in direct contact with the bottom 101a of the housing part 101 over its entire length and is connected thereto by welding over at least several sections, preferably over its entire length. The edge 115e of the cathode current collector 115 is in direct contact with the contact plate 105 over its entire length and is connected thereto by welding over at least several sections, preferably over its entire length.

The contact plate 105 is in turn electrically connected to the housing part 102 via the electrical conductor 107. Preferably, a welded connection consists of the conductor 107 and the contact plate 105 on one side and the conductor 107 and the housing part 102 on the other side.

For an improved overview, no further components of the electrode-separator assembly 104 (in particular separators and electrode materials) are shown—apart from the current collectors 110 and 115.

The housing parts 101 and 102 are electrically insulated from each other by the seal 103. The housing is closed, for example, by flanging. The housing part 101 forms the negative pole and the housing part 102 the positive pole of the cell 100.

FIG. 8 shows a cell 100 with a housing comprising a first housing part 101 and a second housing part 102. The electrode-separator assembly 104 is enclosed in the housing. The housing is cylindrical overall, the housing part 101 has a circular bottom 101a, a hollow cylindrical shell 101b and a circular opening opposite the bottom 101a. The housing part 102 serves to close the circular opening and is formed as a circular lid. The electrode-separator assembly 104 is in the form of a cylindrical winding with two terminal end faces.

In the case of prismatic housings, a section through the cell could look exactly the same. The housing part 101 in this case would have a rectangular bottom 101a, a rectangular side wall 101b and a rectangular cross-section as well as a rectangular opening, the housing part 102 would be formed as a rectangular lid to close the rectangular opening. And the reference sign 104 in this case would not denote an electrode-separator assembly in cylindrical form but a stack of several identical electrode-separator assemblies or a prismatic winding.

The free edge strip 121 of an anode current collector 110 protrudes from one end face of the electrode-separator assembly 104, and the free edge strip 117 of a cathode current collector 115 protrudes from the other end face. The edge 110e of the anode current collector 110 is in direct contact with the bottom 101a of the housing part 101 over its entire length and is connected thereto by welding over at least several sections, preferably over its entire length. The edge 115e of the cathode current collector 115 is in direct contact with the contact plate 105 over its entire length and is connected thereto by welding over at least several sections, preferably over its entire length.

The contact plate 105 is directly connected, preferably welded, to the metallic pole stud 108. This is led out of the housing through an opening in the housing part 102 and insulated from the housing part 102 by means of the electrical insulation 106. The pole stud 108 and the electrical insulation 106 together form a pole bushing.

For an improved overview, no other components of the electrode-separator assembly 104 (in particular separators and electrode materials) are shown apart from the current collectors 110 and 115.

In the bottom 101a there is a hole 109 which is closed, for example by means of soldering, welding or gluing, and which can be used, for example, to introduce electrolyte into the housing. Alternatively, a hole could have been made in the housing part 102 for the same purpose.

The housing part 102 is welded into the circular opening of the housing part 101. The housing parts 101 and 102 therefore have the same polarity and form the negative pole of the cell 100. The pole stud 108 forms the positive pole of the cell 100.

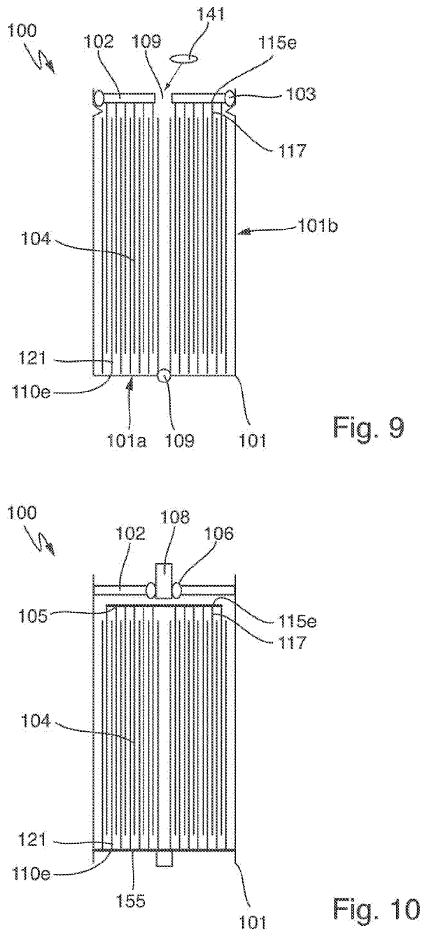

FIG. 9 shows a cell 100 with a housing comprising a first housing part 101 and a second housing part 102. The electrode-separator assembly 104 is enclosed in the housing. The housing is cylindrical overall, the housing part 101 has a circular bottom 101a, a hollow cylindrical shell 101b and a circular opening opposite the bottom 101a. The housing part 102 serves to close the circular opening and is formed as a circular lid. The electrode-separator assembly 104 is in the form of a cylindrical winding with two terminal end faces.

In the case of prismatic housings, a section through the cell could look exactly the same. The housing part 101 in this case would have a rectangular bottom 101a, a rectangular side wall 101b and a rectangular cross-section as well as a rectangular opening, the housing part 102 would be formed as a rectangular lid to close the rectangular opening. And the reference sign 104 in this case would not denote an electrode-separator assembly in cylindrical form but a stack of several identical electrode-separator assemblies or a prismatic winding.

The free edge strip 121 of an anode current collector 110 protrudes from one end face of the electrode-separator assembly 104, and the free edge strip 117 of a cathode current collector 115 protrudes from the other end face. The edge 110e of the anode current collector 110 is in direct contact with the bottom 101a of the housing part 101 over its entire length and is connected thereto by welding over at least several sections, preferably over its entire length. The edge 115e of the cathode current collector 115 is in direct contact with the housing part 102 over its entire length and is connected thereto by welding over at least several sections, preferably over its entire length.

For an improved overview, no further components of the electrode-separator assembly 104 (in particular separators and electrode materials) are shown here, apart from the current collectors 110 and 115.

In the bottom 101a, a hole 109 is found which is closed, for example, by means of soldering, welding or gluing, and which can serve, for example, to introduce electrolyte into the housing. Another hole 109, which can serve the same purpose, is found here in the housing part 102. Preferably, this is closed with the pressure relief valve 141, which can be welded onto the housing part 102, for example.

The holes 109 shown are generally not both needed. In many cases, the cell 100 shown in FIG. 9 therefore only has one of the two holes.

The housing parts 101 and 102 are electrically insulated from each other by the seal 103. The housing is closed, for example, by crimping. The housing part 101 forms the negative pole and the housing part 102 the positive pole of the cell 100.

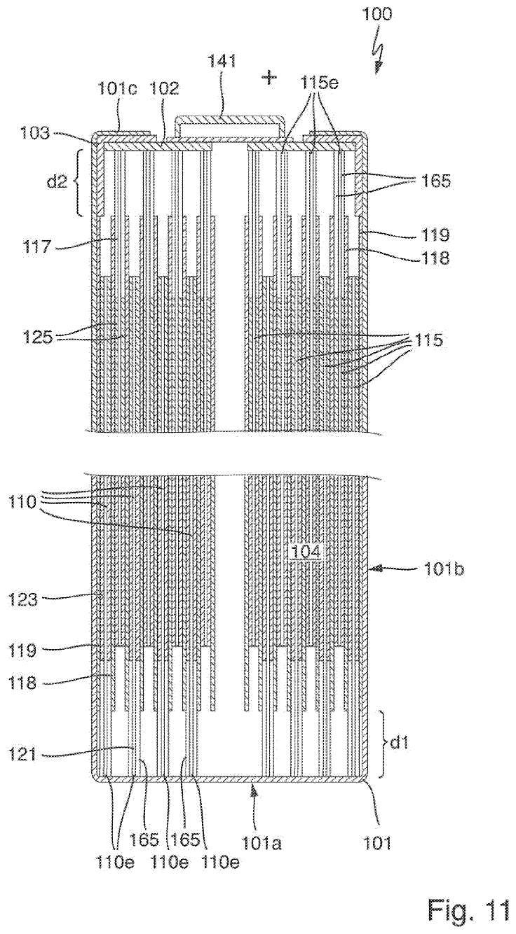

FIG. 10 illustrates a cell 100 having a housing comprising a first housing part 101 and a second housing part 102 and a third housing part 155. The electrode-separator assembly 104 is enclosed in the housing. The housing is generally cylindrical, the housing part 101 being a hollow cylinder with two circular end-face openings. The housing parts 102 and 155 serve to close the circular openings and are formed as circular lids. The electrode-separator assembly 104 is in the form of a cylindrical winding with two terminal end faces.

In the case of prismatic housings, a section through the cell could look exactly the same. In this case, the housing part 101 would have a rectangular cross-section and two rectangular openings, and the housing parts 102 and 155 would be rectangular lids to close the rectangular openings. And the reference sign 104 would in this case not denote an electrode-separator assembly in cylindrical form but a stack of several identical electrode-separator assemblies or a prismatic winding.

The free edge strip 121 of an anode current collector 110 protrudes from one end face of the electrode-separator assembly 104, and the free edge strip 117 of a cathode current collector 115 protrudes from the other end face. The edge 110e of the anode current collector 110 is in direct contact with the housing part 155 over its entire length and is connected thereto by welding over at least several sections, preferably over its entire length. The housing part 155 thus also functions as a contact plate. The edge 115e of the cathode current collector 115 is in direct contact with the contact plate 105 over its entire length and is connected thereto by welding over at least several sections, preferably over its entire length.

For an improved overview, no further components of the electrode-separator assembly 104 (in particular separators and electrode materials) are shown here, apart from the current collectors 110 and 115.

The contact plate 105 is directly connected, preferably welded, to the metallic pole stud 108. This is led out of the housing through an opening in the housing part 102 and insulated from the housing part 102 by means of the electrical insulation 106. The pole stud 108 and the electrical insulation 106 together form a pole bushing.

In the housing part 102 there is a hole 109 which is closed, for example by means of soldering, welding or gluing, and which can be used, for example, to introduce electrolyte into the housing. Alternatively, a hole could have been made in the housing part 155 for the same purpose.

The housing parts 102 and 155 are welded into the circular openings of the housing part 101. The housing parts 101, 102 and 155 therefore have the same polarity and form the negative pole of the cell 100. The pole bolt 108 forms the positive pole of the cell 100.

FIG. 11 shows a cell 100 with a housing comprising a first housing part 101 and a second housing part 102. The electrode-separator assembly 104 is enclosed in the housing. The housing is cylindrical overall, the housing part 101 has a circular bottom 101a, a hollow cylindrical shell 101b and a circular opening opposite the bottom 101a. The housing part 102 serves to close the circular opening and is formed as a circular lid. The electrode-separator assembly 104 is in the form of a cylindrical winding with two terminal end faces.

In the case of prismatic housings, a section through the cell could look exactly the same. The housing part 101 in this case would have a rectangular bottom 101a, a rectangular side wall 101b and a rectangular cross-section as well as a rectangular opening, the housing part 102 would be formed as a rectangular lid to close the rectangular opening. And the reference sign 104 in this case would not denote an electrode-separator assembly in cylindrical form but a stack of several identical electrode-separator assemblies or a prismatic winding.

The free edge strip 121 of an anode current collector 110 protrudes from one end face of the electrode-separator assembly 104, and the free edge strip 117 of a cathode current collector 115 protrudes from the other end face. The edge 110e of the anode current collector 110 is in direct contact with the bottom 101a of the housing part 101 over its entire length and is connected thereto at least over several sections, preferably over its entire length, by welding.

The edge 115e of the cathode current collector 115 is in direct contact with the housing part 102 over its entire length and is connected to it by welding over at least several sections, preferably over its entire length. The housing part 102 thus serves here simultaneously as a contact plate.

The anode current collector 110 is loaded on both sides with a layer of negative electrode material 123, but has a free edge strip 121 extending along the longitudinal edge 110e which is not loaded with the electrode material 123. Instead, the free edge strip 121 is coated on both sides with a ceramic support material 165.

The cathode current collector 115 is loaded on both sides with a layer of negative electrode material 125, but has a free edge strip 117 extending along the longitudinal edge 115e which is not loaded with the electrode material 125. Instead, the free edge strip 117 is coated on both sides with a ceramic support material 165.

The electrode-separator assembly 104 has two end faces formed by the longitudinal edges 118a and 119a and 118b and 119b of the separators 118 and 119. The longitudinal edges of the current collectors 110 and 115 protrude from these end faces. The corresponding projections are marked d1 and d2.

In the housing part 102 there is a hole 109 which can be used, for example, to introduce electrolyte into the housing. The hole is closed by the pressure relief valve 141, which is connected to the housing part 102, for example by welding.

The housing parts 101 and 102 are electrically insulated from each other by the seal 103. The housing is closed by crimping. For this purpose, the opening edge 101c of the housing part is bent radially inwards. The housing part 101 forms the negative pole and the housing part 102 the positive pole of the cell 100.

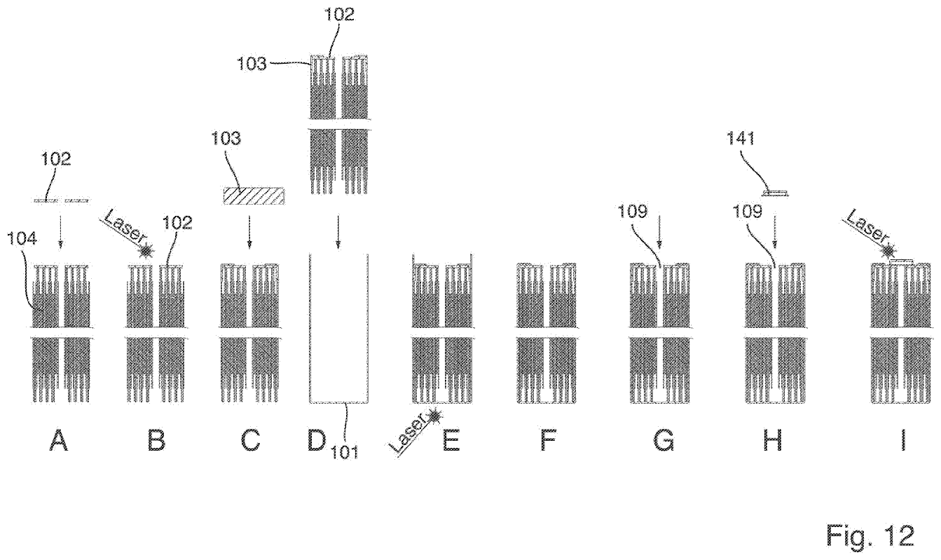

The cell shown in FIG. 11 can be manufactured according to FIG. 12, the individual process steps A to I are described below. First, the electrode-separator assembly 104 is provided, on the upper end face of which the housing part 102 serving as a contact plate is placed. In step B, this is welded to the longitudinal edge 115e of the cathode current collector 115. In step C, the circumferential seal 103 is drawn onto the edge of the housing part 102. With this, in step D, the electrode-separator assembly 104 is inserted into the housing part 101 until the longitudinal edge 110e of the anode current collector 110 is in direct contact with the bottom 101a of the housing part 101. In step E, this is welded to the bottom 101a of the housing part 101. In step F, the housing is closed by crimping. To do this, the opening edge 101c of the housing part 101 is bent radially inwards. In step G, the housing is filled with electrolyte, which is dosed into the housing through the opening 109. The opening 109 is closed in steps H and I by means of the pressure relief valve 141, which is welded onto the housing part 102.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A lithium ion cell, comprising:
a ribbon-shaped electrode-separator assembly comprising an anode, a separator, and a cathode in a sequence anode/separator/cathode, the electrode-separator assembly being (a) formed as a winding with two terminal end faces or (b) part of a stack formed of two or more identical electrode-separator assemblies, the stack having two terminal sides, wherein:
the anode comprises a ribbon-shaped anode current collector having a first longitudinal edge, a second longitudinal edge, and two ends,
the anode current collector comprises a strip-shaped main region loaded with a layer of negative electrode material and a free edge strip extending along the first longitudinal edge that is not loaded with the electrode material,
the cathode comprises a ribbon-shaped cathode current collector having a first longitudinal edge, a second longitudinal edge, and two ends,
the cathode current collector has a strip-shaped main region loaded with a layer of positive electrode material and a free edge strip extending along the first longitudinal edge that is not loaded with the electrode material,
the electrode-separator assembly is enclosed in a housing,
the anode and the cathode are formed and/or arranged within the electrode-separator assembly relative to each other such that the first longitudinal edge of the anode current collector protrudes from one of the terminal end faces or terminal sides of the stack and the first longitudinal edge of the cathode current collector protrudes from the other of the terminal end faces or terminal sides of the stack; and
a contact sheet metal member is in direct contact with a respective longitudinal edge, the respective longitudinal edge being the first longitudinal edge of the anode current collector or the first longitudinal edge of the cathode current collector,
the contact sheet metal member being connected to the respective longitudinal edge by welding,
wherein a part of the housing serves as the contact sheet metal member and/or the contact sheet metal member forms a part of the housing enclosing the electrode-separator assembly.

2. The cell according to claim 1, wherein following additional features:
the housing comprises a cup-shaped first housing part including a bottom, a circumferential side wall, and an opening and a second housing part closing the opening, and
the contact sheet metal member is the bottom of the first housing part.

3. The cell according to claim 2, wherein:
the first longitudinal edge of the anode current collector is in direct contact with a first respective contact sheet metal member and connected to the first respective contact sheet metal member by welding,
the first longitudinal edge of the cathode current collector is in direct contact with a second respective contact sheet metal member and connected to the second respective contact sheet metal member by welding,
the bottom of the first housing part is the first respective contact sheet metal member or the second respective contact sheet metal member,
an electrical conductor connects the second housing part to the one of the first respective contact sheet metal member or the second respective contact sheet metal member that is not the bottom of the first housing part,
the cell further comprises an electrical seal that electrically isolates the first housing part and the second housing part from each other.

4. The cell according to claim 2, wherein:
the first longitudinal edge of the anode current collector is in direct contact with a first respective contact sheet metal member and connected to the first respective contact sheet metal member by welding,
the first longitudinal edge of the cathode current collector is in direct contact with a second respective contact sheet metal member and connected to the second respective contact sheet metal member by welding,
the bottom of the first housing part is the first respective contact sheet metal member or the second respective contact sheet metal member,
the second housing part is welded into the opening of the first housing part and comprises a pole bushing through which an electrical conductor is led out of the housing.
the electrical conductor is connected to the one of the first respective contact sheet metal member or the second respective contact sheet metal member that is not the bottom of the first housing part.

5. The cell according to claim 2, wherein:
the first longitudinal edge of the anode current collector is in direct contact with a first respective contact sheet metal member and to which this longitudinal edge is connected to the first respective contact sheet metal member by welding,
the first longitudinal edge of the cathode current collector is in direct contact with a second respective contact sheet metal member and connected to the second respective contact sheet metal member by welding,
the bottom of the first housing part is the first respective contact sheet metal member or the second respective contact sheet metal member,
the second housing member is the one of the first respective contact sheet metal member or the second respective contact sheet metal member that is not the bottom of the first housing part, and
the cell further comprises an electrical seal that electrically isolates the first housing part and the second housing part from each other.

6. The cell according to claim 1, wherein:
the housing comprises a tubular first housing part having two terminal openings, a second housing part closing a first terminal opening, and a third housing part closing a second terminal opening.
the contact sheet metal member is the second housing part or the third housing part.

7. The cell according to claim 6 wherein:
the first longitudinal edge of the anode current collector is in direct contact with a first respective contact sheet metal member and connected to the first respective contact sheet metal member by welding,
the first longitudinal edge of the cathode current collector is in direct contact with a second respective contact sheet metal member and connected to the second respective contact sheet metal member by welding.
the second housing part is the first respective contact sheet metal member or the second respective contact sheet metal member, the second housing part being welded into the first terminal opening,
the third housing part is welded into the second terminal opening, the third housing part comprising a pole bushing through which an electrical conductor is led out of the housing, and
the one of the first respective contact sheet metal member or the second respective contact sheet metal member that is not the second housing part is electrically connected to the electrical conductor.

8. The cell according to claim 6 wherein:
the first longitudinal edge of the anode current collector is in direct contact with a first respective contact sheet metal member and connected to the first respective contact sheet metal member by welding,
the first longitudinal edge of the cathode current collector is in direct contact with a second respective contact sheet metal member and connected to the second respective contact sheet metal member by welding,
the second housing part is the first respective contact sheet metal member or the second respective contact sheet metal member, the second housing part being welded into the first terminal opening,
the third housing part is the one of the first respective contact metal sheet member or the second respective contact metal sheet member that is not the second housing part, the third housing part being insulated from the first housing part via a seal.

9. A method of manufacturing a cell having the features of claim 1, the method comprising:
providing the electrode-separator assembly with the two terminal end faces or the two terminal sides from which the first longitudinal edge of the anode current collector and the first longitudinal edge of the cathode current collector protrude;
providing the contact sheet metal member for electrically contacting the respective longitudinal edge; and
welding the respective longitudinal edge to the contact sheet metal member.

10. The method according to claim 9, further comprising:
providing a cup-shaped first housing part having a bottom, a peripheral side wall, and an opening;
inserting the electrode-separator assembly is inserted into the cup-shaped housing until the first longitudinal edge of the anode current collector or the first longitudinal edge of the cathode current collector is in direct contact with the bottom of the first housing part;
welding the first longitudinal edge of the anode current collector or the first longitudinal edge of the cathode current collector to the bottom of the first housing part;
closing the opening of the first housing part with a second housing part.

11. The method according to claim 9, further comprising:
bringing the contact sheet metal member into direct contact with the first longitudinal edge of the electrode current collector;
bringing a second contact sheet metal member into direct contact with the first longitudinal edge of the cathode current collector and welding the second contact sheet metal member to the first this longitudinal edge of the electrode current collector;
providing a tubular first housing part with two end face openings;
inserting the electrode-separator assembly into the tubular first housing part through one of the two end-face openings;
welding the contact sheet metal member or the second contact sheet metal member into one of the end openings of the first housing part as a second housing part; and
welding a third housing part, which comprises a pole bushing configured to allow an electrical conductor to be led out of the housing into the other of the end faces of the first housing part.

12. The method according to claim 9, further comprising:
filling the housing with an electrolyte through a hole in one of the housing parts.

13. The method according to claim 12, further comprising closing, after the filling, the hole by welding, gluing, riveting or soldering.
